(19) United States
(12) Patent Application Publication
(10) Pub. No.: US 2010/0149356 A1
(43) Pub. Date: Jun. 17, 2010

(54) DISPLAY METHOD AND PHOTOGRAPHING APPARATUS AND DISPLAY APPARATUS USING THE SAME

(75) Inventors: Young-hoon KIM, Seoul (KR); In-ho Kim, Suwon-si (KR); Seung-ho Lee, Suwon-si (KR); Sun-young Gu, Seoul (KR); Byoung-woo Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/606,354

(22) Filed: Oct. 27, 2009

(30) Foreign Application Priority Data
Dec. 17, 2008 (KR) 2008-128757

(51) Int. Cl. H04N 5/232; H04N 5/222

(52) U.S. Cl. 348/211.8; 348/333.02; 348/E05.022; 348/E07.085

(57) ABSTRACT

A display method and a photographing apparatus and display apparatus using the display method include displaying a photographed image and received images, and changing a mode of one of the images when a display area of one of the images is changed. Therefore, it is possible to view or record one or more images photographed by one or more external photographing apparatuses in real-time.

### CROSS-REFERENCE TO RELATED APPLICATIONS

This application claims priority under 35 U.S.C. §119 (a) from Korean Patent Application No. 10-2008-0128757, filed on Dec. 17, 2008, in the Korean Intellectual Property Office, the disclosure of which is incorporated herein by reference in its entirety.

### BACKGROUND

1. Field of the Invention

The present general inventive concept relates to a display method, and a photographing apparatus and display apparatus using the display method. More particularly, the present general inventive concept relates to a display method, and a photographing apparatus and display apparatus using the display method to display an image received from an external photographing apparatus.

2. Description of the Related Art

Photographing apparatuses such as digital cameras and camcorders have become widespread, and mobile communication terminals with built-in photographing apparatuses are being widely used, and thus users can easily photograph images.

However, when a user desires to view images photographed by another user's photographing apparatus using his or her photographing apparatus, there is a need to receive data through additional transferring means such as cables or storage media. Accordingly, if there is no additional transferring means, it is difficult for the user to view images photographed by another user's photographing apparatus on his or her photographing apparatus.

In order to address this problem, various methods are needed to enable a user to view images photographed by another user's photographing apparatuses via wireless networks. It is also difficult for the user to view these images in real-time.

### SUMMARY

The present general inventive concept provides a display method, and a photographing apparatus and display apparatus using the display method in order for a user to view or record an image photographed by another user's photographing apparatus in real-time.

Additional features and utilities of the present general inventive concept will be set forth in part in the description which follows and, in part, will be obvious from the description, or may be learned by practice of the general inventive concept.

Exemplary embodiments of the present general inventive concept may be achieved by providing a display method of a photographing apparatus, including displaying an image photographed by the photographing apparatus and at least one image received from at least one external photographing apparatus on a first area or a second area; and changing a mode of at least one of the photographed image and the at least one received image, if a display area of the at least one image is changed.

The first area may be a moving image mode area on which a moving image is displayed, and the second area may be a still image mode area on which a still image is displayed.

The changing of the mode may include, if a display area of the at least one received image is changed from the second area to the first area, transmitting a moving image request message to the at least one external photographing apparatus; and displaying a moving image received from the at least one external photographing apparatus on the first area.

The changing of the mode may include, if a display area of the at least one received image is changed from the first area to the second area, transmitting a still image request message to the at least one external photographing apparatus; and updating a still image received periodically from the at least one external photographing apparatus and displaying the updated image on the second area.

The display method may further include, if one image is selected from the first area, highlighting and recording the selected image.

The display method may further include outputting the selected image along with an audio corresponding to the selected image.

The display method may further include, if the selected image is exchanged with a non-selected image, pausing recording of the selected image and starting recording of the non-selected image.

The second area may enclose the first area.

The displaying of the photographed image and at least one received image may include detecting a position of the at least one external photographing apparatus based on an object in the at least one received image; and displaying the at least one received image around the photographed image according to the detected position.

The display method may further include checking a direction and size of the object; and receiving distance information and zoom information associated with the at least one external photographing apparatus from the at least one external photographing apparatus. The detecting of the position of the at least one external photographing apparatus may include detecting the position of the at least one external photographing apparatus using at least one of the direction and size of the object and the distance information and zoom information.

The displaying of the photographed image and at least one received image may include displaying the photographed image and at least one received image so that a size or position of either the photographed image or the at least one received image may be changed according to the number of images displayed on the first area and the second area.

Exemplary embodiments of the present general inventive concept may also be achieved by providing a display method including receiving a plurality of images from a plurality of external apparatuses; dividing a screen into a plurality of areas; and displaying each of the plurality of images in at least one of the plurality of areas in a different display mode, based on the area of areas of the screen on which the each of the plurality of images is displayed.

Exemplary embodiments of the present general inventive concept may also be achieved by providing a photographing apparatus including a display unit to display an image photographed by the photographing apparatus and at least one image received from at least one external photographing apparatus on a first display area or a second display area; and a controller to change a mode of at least one of the photographed image and the at least one received image, if a display area of the at least one image is changed.

The first display area may be a moving image mode area on which a moving image is displayed, and the second display area may be a still image mode area on which a still image is displayed.

The photographing apparatus may further include a communication module to communicate with the at least one external photographing apparatus. If a display area of the at least one received image is changed from the second display area to the first display area, the controller may control the communication module to transmit a moving image request message to the at least one external photographing apparatus so that a moving image received from the at least one external photographing apparatus in response to the moving image request message may be displayed on the first display area.

The photographing apparatus may further include a communication module to communicate with the at least one external photographing apparatus. If a display area of the at least one received image is changed from the first display area to the second display area, the controller may control the communication module to periodically transmit a still image request message to the at least one external photographing apparatus so that a still image received periodically from the at least one external photographing apparatus in response to the still image request message may be updated and displayed on the second display area.

The photographing apparatus may further include a storage unit to record an image. If one image is selected from the first display area, the controller may control the selected image to be highlighted and recorded on the storage unit.

The photographing apparatus may further include an audio output unit to output an audio. The controller may control the selected image along with an audio corresponding to the selected image to be output.

If the selected image is exchanged with a non-selected image, the controller may control recording of the selected image to be paused and control recording of the non-selected image to be started.

The second display area may enclose the first display area.

The controller may detect a position of the at least one external photographing apparatus based on an object in the at least one received image, and may control the at least one received image to be displayed around the photographed image according to the detected position.

The photographing apparatus may further include a communication module to receive distance information and zoom information associated with the at least one external photographing apparatus from the at least one external apparatus. The controller may check a direction and size of the object, and detect the position of the at least one external photographing apparatus using at least one of the direction and size of the object and the distance information and zoom information.

The controller may control a size or position of either the photographed image or the at least one received image to be changed according to the number of images displayed on the first area and the second area.

The display unit may be a touch screen, and the display area of at least one of the photographed image and the at least one received image may be changed by a user input on the touch screen.

Exemplary embodiments of the present general inventive concept may also be achieved by providing a display apparatus including a communication module to receive a plurality of images from a plurality of external apparatuses; and a controller to divide a screen into a plurality of areas, and control the plurality of images to be displayed in different display modes based on one or more areas of the plurality of areas of the screen on which the plurality of images are displayed.

Exemplary embodiments of the present general inventive concept may also be achieved by providing a computer-readable medium having executable code stored thereon to perform a display method of a photographing apparatus, the method including displaying an image photographed by the photographing apparatus and at least one image received from at least one external photographing apparatus on a first area or a second area, and changing a mode of at least one of the photographed image and the at least one received image if a display area of the at least one image is changed.

Exemplary embodiments of the present general inventive concept may also be achieved by providing a display method to display images on a screen having at least two display areas, the method including receiving a first image from a first photographing apparatus and at least one second image from a second photographing apparatus, and displaying the first image and the second image on the screen in a display mode according to the display area of the screen in which the first image and the second image are displayed.

The display mode may be one of a moving picture mode and a still picture mode.

The method may further including changing the display mode of the first or second image if the first or second image, respectively, is moved to a different display area of the screen.

If the display mode is a still picture mode, the image displayed in the still picture mode may be periodically updated.

If the display mode is a moving picture mode, the image displayed in the moving picture mode may be recorded.

A display position of the image displayed in the second display area may be determined relative to the image displayed in the first display area according to at least one of distance information, zoom information, directional information, size information, and whether the second image comprises an image displayed in the first image.

Exemplary embodiments of the present general inventive concept may also be achieved by providing a photographing apparatus, including a photographing unit to photograph an object to generate an image, a communication module to communicate with an external apparatus to receive another image, and a display unit having a screen to display the image and the another image.

The communication module may further comprise a wireless communication module to wirelessly communicate with the external apparatus.

The external apparatus may further comprise another photographing apparatus or a server a connected to the another photographing apparatus.

### BRIEF DESCRIPTION OF THE DRAWINGS

These and/or other features and utilities of the present general inventive concept will become apparent and more readily appreciated from the following description of certain exemplary embodiments, taken in conjunction with the accompanying drawings of which:

FIG. 1 is a view illustrating a concept of a photographing system according to an exemplary embodiment of the present general inventive concept;

FIG. 2 is a block diagram illustrating a photographing apparatus according to an exemplary embodiment of the present general inventive concept;

FIG. 3 is a flowchart illustrating an image display process according to an exemplary embodiment of the present general inventive concept;

FIG. 4 exemplarily illustrates a screen displayed when an image share set command is input;

FIG. 5 is a flowchart illustrating a process of changing a display position of an image according to an exemplary embodiment of the present general inventive concept;

FIGS. 6A to 6B exemplarily illustrate a screen displayed when a user drags an image;

FIG. 7 is a flowchart illustrating an image recording process according to an exemplary embodiment of the present general inventive concept;

FIGS. 8A to 8D exemplarily illustrate a screen displayed when an image to be highlighted and recorded is changed according to a change in the display position;

FIG. 9 is a flowchart illustrating a process of rearranging a photographed image and received images;

FIG. 10 is a view illustrating a screen displayed when a photographed image and received images are rearranged; and

FIG. 11 is a view illustrating a screen displayed when a photographed image and received images are rearranged in a different manner from the screen of FIG. 10.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

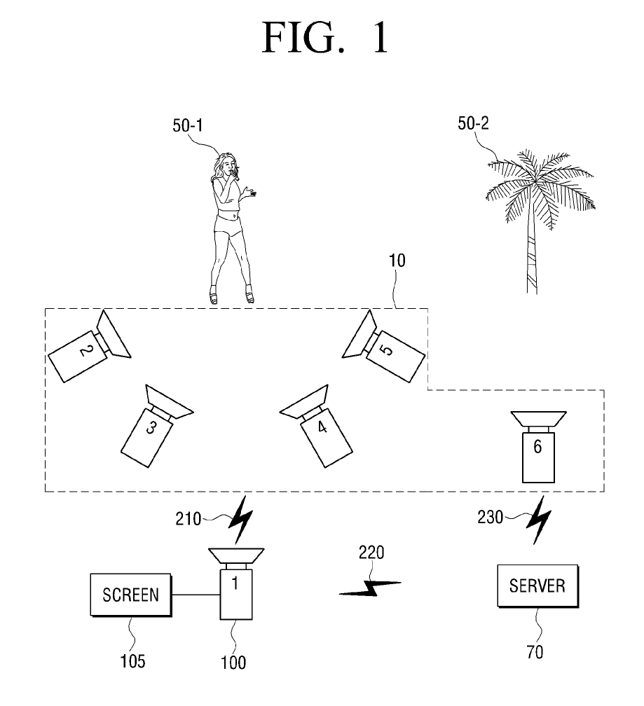

FIG. 1 is a view illustrating a concept of a photographing system according to an exemplary embodiment of the present general inventive concept. The photographing system of FIG. 1 includes a user's photographing apparatus 100 (hereinafter referred to as a ‘photographing apparatus’), another user's photographing apparatus 10 (hereinafter, is referred to as an ‘external photographing apparatus’), and a server 70.

The photographing apparatus 100 and the external photographing apparatus 10 may photograph objects 50-1 and 50-2 to generate and display a plurality of images on a screen 105.

As illustrated in FIG. 1, the photographing apparatus 100 may directly communicate with the external photographing apparatus 10 through a connection 210, and may display an image photographed by the external photographing apparatus 10 on the screen 105 in real-time. When the photographing apparatus 100 is not able to directly communicate with the external photographing apparatus 10, the photographing apparatus 100 may receive the image photographed by the external photographing apparatus 10 via the server 70 from the external photographing apparatus 10 through connections 220 and 230 and display the image on the screen 105 in real-time.

Whether the photographing apparatus 100 communicates with the external photographing apparatus 10 directly or via the server 70 may be determined according to the communication state between the photographing apparatus 100 and the external photographing apparatus 10, or a distance between the photographing apparatus 100 and the external photographing apparatus 10, or the connection state between the photographing apparatus 100 and the server 70. In an exemplary embodiment, even when the photographing apparatus 100 is able to communicate with the external photographing apparatus 10, the server 70 may be used to transfer an image photographed by the external photographing apparatus 10 to the photographing apparatus 100.

Referring to FIG. 1, the photographing apparatus 100 and external photographing apparatuses 2 to 5 can photograph the same object 50-1, while only the external photographing apparatus 6 can photograph the object 50-2, but this is merely an example and any of the photographing apparatuses 2-6 and photographing apparatus 100 can photograph any of the objects 50-1 and 50-2. Accordingly, the present general inventive concept is not applicable to only a situation in which direct communication is performed according to whether or not the same object is photographed.

The photographing apparatuses 10 and 100 and the server 70 can communicate wirelessly. The photographing apparatus 100 may use a wireless device such as a wireless fidelity (Wi-Fi) module to directly receive images from the external photographing apparatus 10 and/or a Worldwide Interoperability for Microwave Access (WiMAX) module to receive images from the external photographing apparatus 10 via the server 70. However, this is not intended as a limitation, and any wireless device and/or protocol may be used to enable communication between the photographing apparatuses 10 and 100 and the server 70.

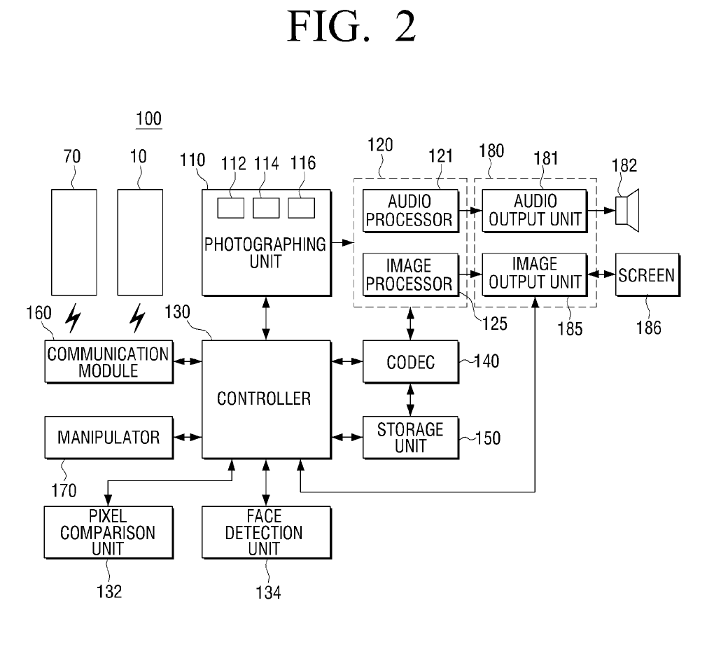

FIG. 2 is a block diagram illustrating the photographing apparatus 100 of FIG. 1 according to an exemplary embodiment of the present general inventive concept. As illustrated in FIG. 2, the photographing apparatus 100 may communicate with the external photographing apparatus 10 and/or the server 70 to receive and display the image photographed by the external photographing apparatus 10 in real-time.

The photographing apparatus 100 of FIG. 2 includes a photographing unit 110, a signal processor 120, a controller 130, a codec 140, a storage unit 150, a communication module 160, a manipulator 170 and an output unit 180.

The photographing unit 110 may convert an optical signal input through a lens (not illustrated) into an electrical signal, and can perform predetermined signal processing on the electrical signal.

The photographing unit 110 may include an image sensor 112 to output an analog image signal, and an analog-digital-converter 114 (ADC) to convert an analog image signal into a digital image signal.

Additionally, the photographing unit 110 may convert an analog audio signal input through a microphone 116 into a digital audio signal.

The signal processor 120 may perform signal processing on the image signal and audio signal output from the photographing unit 110. The signal processor 120 includes an audio processor 121 and an image processor 125.

The audio processor 121 may convert the audio signal received from the photographing unit 110 into an audio signal having a format capable of being output through a speaker included in an audio output unit 181 that will be further described below. Additionally, the audio processor 121 may transmit the processed audio signal to the codec 140 in order to store a captured audio.

The image processor 125 may perform signal processing, such as format conversion, digital zooming to adjust an image scale, automatic white balancing (AWB), automatic focus (AF) and/or automatic exposure (AE), on the image signal received from the photographing unit 110, and may transfer the processed image signal to an image output unit 185 that will be described below. Additionally, the image processor 125 may transmit the processed image signal to the codec 140 in order to store a captured image.

The codec 140 may perform encoding when the captured image and audio are to be stored, and may perform decoding when the stored image and audio are to be output. In more detail, the codec 140 may encode the audio signal and image signal output from the signal processor 120, and may transmit the encoded audio signal and image signal to the storage unit 150. Additionally, the codec 140 may decode the encoded audio signal and image signal stored in the storage unit 150, and may transmit the decoded audio signal and decoded image signal back to the audio processor 121 and the image processor 125, respectively.

The output unit 180 may output audio and an image corresponding to the audio signal and image signal output from the signal processor 120 so that a user may be provided with the audio and image. The output unit 180 includes the audio output unit 181 and the image output unit 185.

The audio output unit 181 may output the audio signal output from the audio processor 121 through a speaker 182, and the image output unit 185 may output the image signal output from the image processor 125 through a touch screen 186.

The storage unit 150 may store the audio and image captured by the photographing unit 110 in predetermined compression formats, and may also store information on a program required to control the photographing apparatus 100 and setting information. The storage unit 150 may be implemented, for example, as a flash memory, a hard disk drive, or a digital versatile disc (DVD).

The communication module 160 may transmit or receive data to or from the external photographing apparatus 10 or the server 70 under the control of the controller 130, further described below. The communication module 160 may receive images photographed by the external photographing apparatus 10 in real-time, and may transmit a moving image request message or a still image request message to the external photographing apparatus 10 in response to a user's manipulation command.

The communication module 160 may include, for example, the Wi-Fi module and/or WiMAX module in order to transmit or receive data to or from the external photographing apparatus 10 as described above.

The manipulator 170 may receive the user's manipulation command and transfer the received manipulation command to the controller 130. Accordingly, the controller 130 may control overall operations of the photographing apparatus 100 in response to a manipulation command input by the user using the manipulator 170. The manipulator 170 can be implemented, for example, as buttons, dials, sliders, or other controls capable of receiving input from a user. The manipulator 170 can also be implemented as a touch screen capable of displaying information and receiving input.

In more detail, the controller 130 may control the photographing unit 110 and signal processor 120 to convert an optical signal into an electrical signal and perform predetermined signal processing on the electrical signal. Additionally, the controller 130 may control the codec 140 to encode the processed audio and image signals and decode the encoded audio and image signals.

In response to the user command input through the manipulator 170, the controller 130 may (1) control a photographed image and received images to be displayed on a plurality of areas into which the screen is divided, (2) control the display position of the images to be changed, (3) control the moving image request message or still image request message to be transmitted to the external photographing apparatus 10 via the communication module 160, (4) control a selected image to be recorded or highlighted, and (5) control the photographed image and received images to be rearranged according to whether or not the photographed image and received images represent the same object.

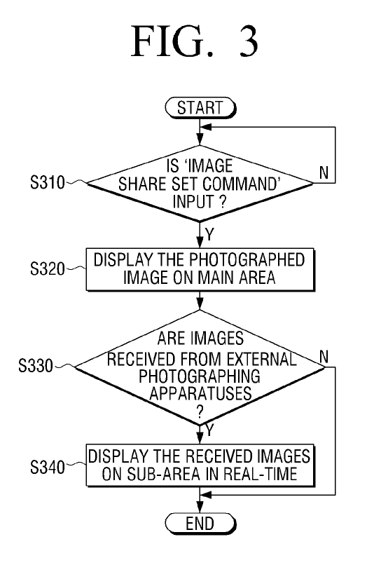

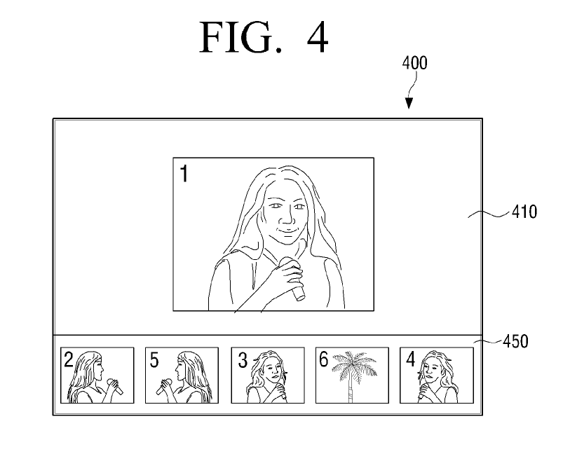

Hereinafter, a process of displaying the photographed image and received images on the plurality of areas into which the screen can be divided will be described with reference to FIGS. 3 and 4.

FIG. 3 is a flowchart explaining an image display process according to an exemplary embodiment of the present general inventive concept. The controller 130 can determine whether or not an image share set command to share images with the external photographing apparatus 10 is input in operation S310.

If it is determined that the image share set command is input in operation S310-Y, the controller 130 may control an image photographed by the photographing apparatus 100 to be displayed on a main area of the screen in operation S320.

Subsequently, the controller 130 may control the communication module 160 to transfer an image request message to the external photographing apparatus 10, and may also determine whether or not one or more images are received from the external photographing apparatus 10 in response to the image request message in operation S330.

If it is determined that one or more images are received from the external photographing apparatus 10 in operation S330-Y, the controller 130 may display the one or more received images on a sub-area of the screen in real-time in operation S340.

The main area 410 and sub-area 450 of the screen 400 are now described with reference to FIG. 4. FIG. 4 exemplarily illustrates a screen 450 displayed when the image share set command is input. The screen 400 can be implemented as a touch screen capable of displaying information and receiving an input, such as commands related to displayed images, as further described below.

In response to the image share set command, the screen of the photographing apparatus 100 is divided into a main area 410 and a sub-area 450, as illustrated in FIG. 4. The main area 410 can display an image photographed by the photographing apparatus 100, and the sub-area 450 can display one or more images photographed by the external photographing apparatus 10.

In this situation, numbers which can be assigned to the photographing apparatus 100 and the external photographing apparatus 10 for identifying purposes can also be displayed on the upper left of each of the displayed images. Accordingly, it is possible for a user to know which photographing apparatus provides which image.

In an exemplary embodiment, the images are displayed in the order of 2, 5, 3, 6 and 4 on the sub-area 450, as illustrated in FIG. 4, so it is possible for a user to know a transmission order of the one or more images photographed by the external photographing apparatus 10. However, this is not intended as a limitation, and the images may be displayed in any order. Also, additional information can be provided, (for example, A, B, C, etc.) to indicate the transmission order of the images if, for example, the images are not displayed in the order of their transmission.

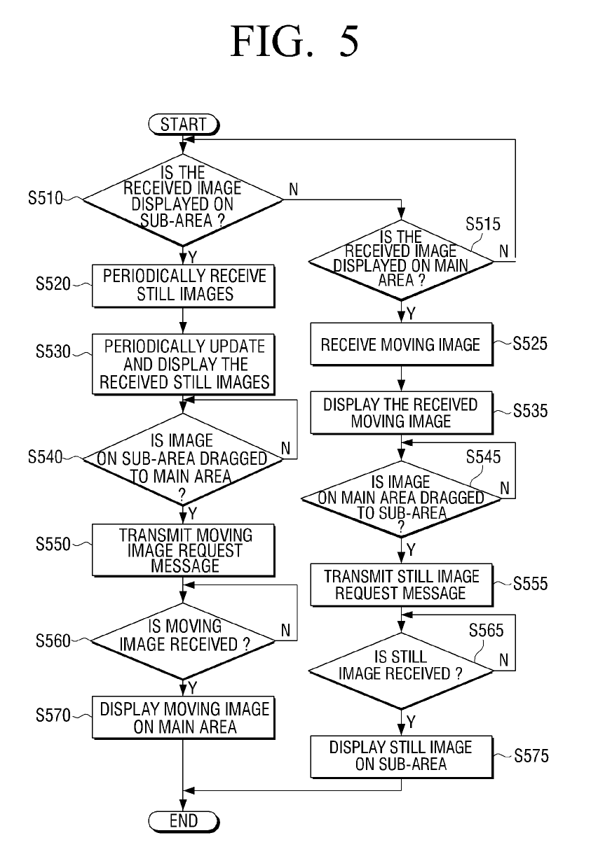

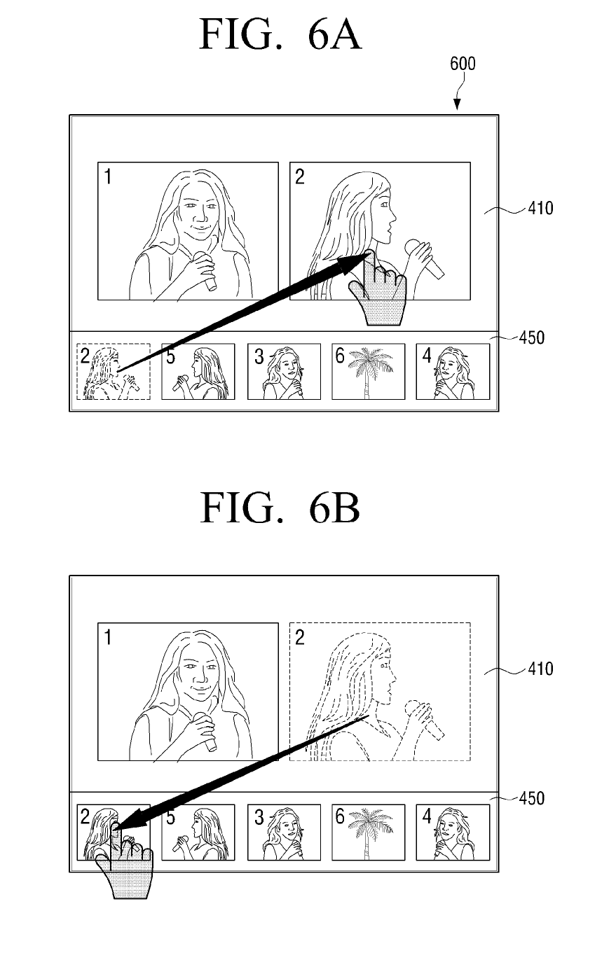

As described above, the controller 130 may control the display position of images to be changed, and control the moving image request message or still image request message to be transmitted to the external photographing apparatus 10 via the communication module 160. Hereinafter, such operations of the controller 130 are now described with reference to FIGS. 5 to 6B.

FIG. 5 is a flowchart illustrating a process of changing the display position of an image according to an exemplary embodiment of the present general inventive concept. The controller 130 can determine whether or not a received image is displayed on the sub-area 450 in operation S510.

If it is determined that the received image is displayed on the sub-area 450 in operation S510-Y, the controller 130 may control the communication module 160 to transmit a request message to an external photographing apparatus that transmitted the image in order to request that still images be received periodically from the external photographing apparatus in operation S520. When still images are received periodically from the external photographing apparatus in response to the request message, the controller 130 may control the received still images to be periodically updated and displayed on the sub-area 450 in operation S530.

Accordingly, the still images received from the external photographing apparatus may be updated and displayed on the sub-area 450 periodically.

Additionally, the controller 130 may determine whether or not a still image appearing on the sub-area 450 is dragged to the main area 410 through a touch screen (as screen 400 may be implemented) in operation S540. Upon determining that the still image on the sub-area 450 is dragged to the main area 410 in operation S540-Y, the controller 130 may control the communication module 160 to transmit a moving image request message to the external photographing apparatus 10 that transmitted the still image in order to receive a moving image from the external photographing apparatus 10 in operation S550.

Subsequently, the controller 130 may determine whether or not the moving image is received via the communication module 160 in operation S560. If it is determined that the moving image is received in operation S560-Y, the controller 130 may control the received moving image to be displayed on the main area 410 in operation S570.

FIGS. 6A and 6B exemplarily illustrate a screen 600 displayed when a user drags an image. When a still image on the sub-area 450 is dragged to the main area 410, as illustrated in FIG. 6A, the still image may be changed to a moving image so that the moving image may be displayed on the main area 410.

In this situation, image (1) currently displayed on the main area 410 may be reduced in size, and image (2) dragged to the main area 410 may be magnified in size, so that images (1) and (2) displayed on the main area 410 may have the same size.

Referring back to FIG. 5, if it is determined that the received image is not displayed on the sub-area 450 in operation S510-N, the controller 130 may determine whether or not the received image is displayed on the main area 410 in operation S515.

Upon determining that the received image is displayed on the main area 410 in operation S515-Y, the controller 130 may control the communication module 160 to transmit a request message to an external photographing apparatus that transmitted the image in order to request that a moving image be received from the external photographing apparatus in operation S525. After receiving the moving image, the controller 130 may cause the received moving image to be displayed on the main area 410 in operation S535.

Accordingly, the moving image received from the external photographing apparatus may be displayed on the main area 410.

Additionally, the controller 130 may determine whether or not the moving image displayed on the main area 410 is dragged to the sub-area 450 through the touch screen (not illustrated) in operation S545. If it is determined that the moving image on the main area 410 is dragged to the sub-area 450 in operation S545-Y, the controller 130 may control the communication module 160 so that a still image request message to an external photographing apparatus that transmitted the moving image in order to receive a still image from the external photographing apparatus in operation S555.

The controller 130 may then determine whether or not the still image is received via the communication module 160 in operation S565. Upon determined that the still image is received in operation S565-Y, the controller 130 may allow the received still image to be displayed on the sub-area 450 in operation S575.

Accordingly, when a moving image appearing on the main area 410 is dragged to the sub-area 450, the moving image may be changed to a still image so that the still image may be displayed on the sub-area 450.

Referring to FIG. 6B, an image appearing on the main area 410 is dragged to the sub-area 450. After being dragged to sub-area 450, a moving image on the main area 410 may be changed to a still image so that the still image may be displayed on the sub-area 450.

In this situation, image 1 currently displayed on the main area 410 may be magnified in size, and image 2 dragged to the sub-area 450 may be reduced in size, as illustrated in FIG. 6B

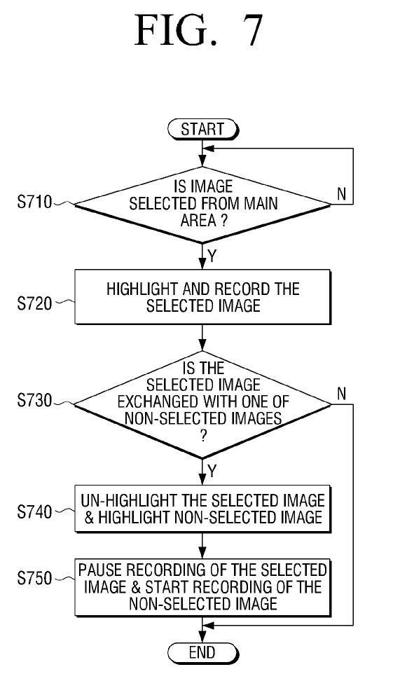

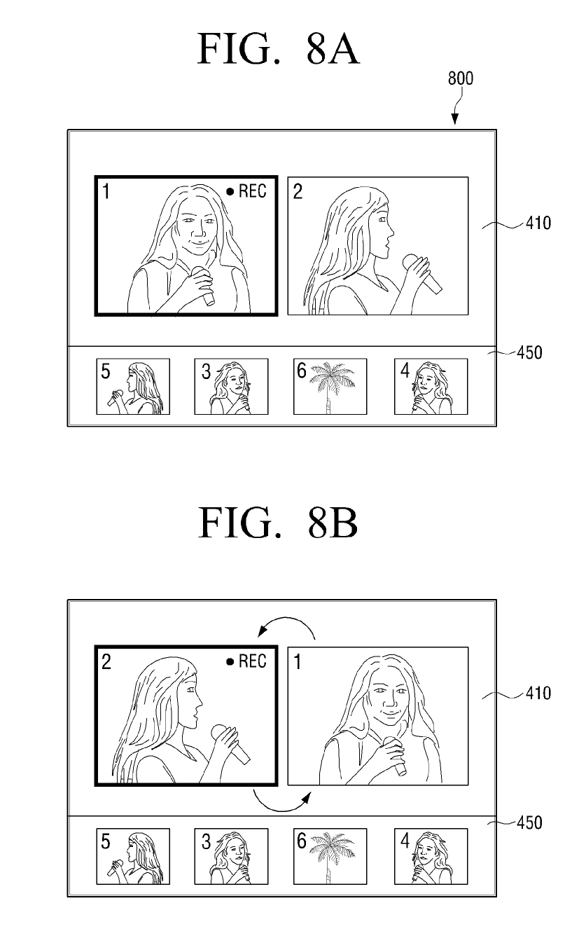

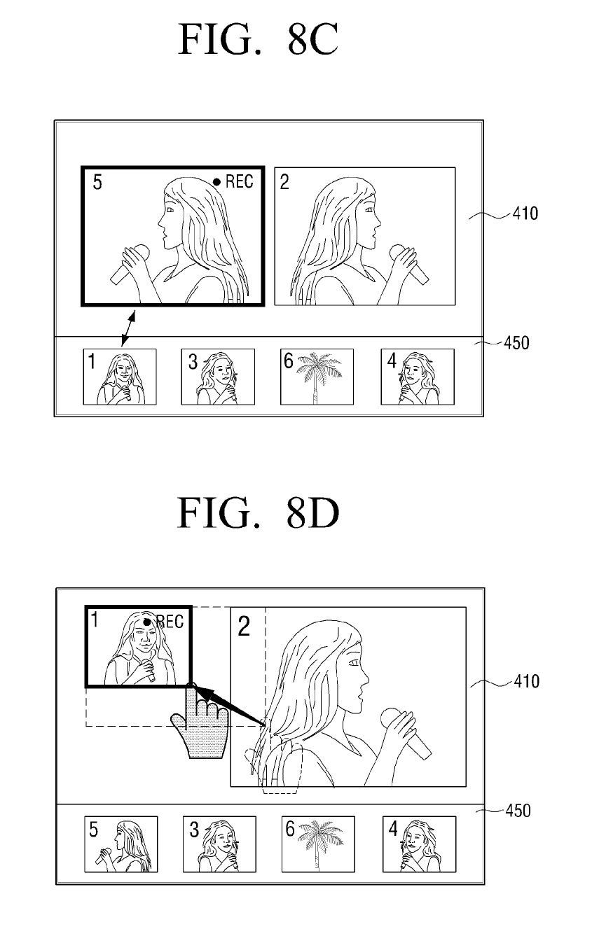

As described above, the controller 130 may control the selected image to be recorded or highlighted. Hereinafter, this operation of the controller 130 is now described with reference to FIGS. 7 to 8D.

FIG. 7 is a flowchart illustrating an image recording process according to an exemplary embodiment of the present general inventive concept. The controller 130 determines whether or not one image is selected from the main area 410 in operation S710. Upon determining that one image is selected from the main area 410 in operation S710-Y, the controller 130 may allow the selected image to be highlighted and recorded on the storage unit 150 in operation S720.

The controller 130 then can determine whether or not the selected image is exchanged with one of non-selected images after a user drags can image displayed in a touch screen (such as screen 800 illustrated in FIG. 8B) in operation S730. If it is determined that a change in the display position between the two images is made in operation S730-Y, the controller 130 may control the selected image to be un-highlighted, and may cause the non-selected image displayed on a portion on which the selected image was displayed to be highlighted in operation S740. Additionally, the controller 130 may control recording of the selected image to be paused and instead control recording of the non-selected image to be started in operation S750.

The image recording process is now described in more detail with reference to FIGS. 8A to 8D. FIGS. 8A to 8D exemplarily illustrate a screen 800 displayed when an image to be highlighted and recorded is changed according to the change in the display position.

In FIG. 8A, when a user selects image 1 from the main area 410, the selected image is highlighted and recording of the selected image 1 is started.

When the user drags image 2 to the position of image 1, or drags image 1 to the position of image 2, the display positions of image 1 and image 2 on the screen 800 may be automatically exchanged, as illustrated in FIG. 8B.

The process of exchanging the display positions of the two images displayed on the main area 410 has been described above, but this is merely an example. The present general inventive concept is also applicable to a situation in which image 5 appearing on the sub-area 450 is exchanged with image 1 appearing on the main area 410 so as to be recorded as illustrated in FIG. 8C. More specifically, FIG. 8A illustrates a screen 800 displaying an image 1 in the main area 410 which is highlighted and which is being recorded. A user may select image 5 in the sub-area 450 and may drag image 5 to the display position of image 1 in the main area 410. In response, image 1 may be automatically reduced in size and may be moved to the display position in the sub-area 450, and image 5 may be enlarged and displayed on the main area 410, as illustrated in FIG. 8C. The image 5 may also be highlighted and the images received and displayed at the new display position may be recorded. In addition, according to the operations described above, when displayed in the sub-area 450, image 1 may be displayed as a still image which is periodically updated, and image 5 may be displayed as a moving image when displayed in the main area 410.

Additionally, a user may desire to view an image that has not been recorded, prior to viewing the currently recorded image. In this situation, the user may drag edges or vertexes of the currently recorded image (for example, image 1) to reduce the size of the currently recorded image so that another image (for example, image 2) may be enlarged, as illustrated in FIG. 8D. However, the reducing of the size of the currently recorded image is merely an example, and the present general inventive concept is equally applicable to a situation in which the user adjusts the size of images other than the currently recorded image by the dragging operation.

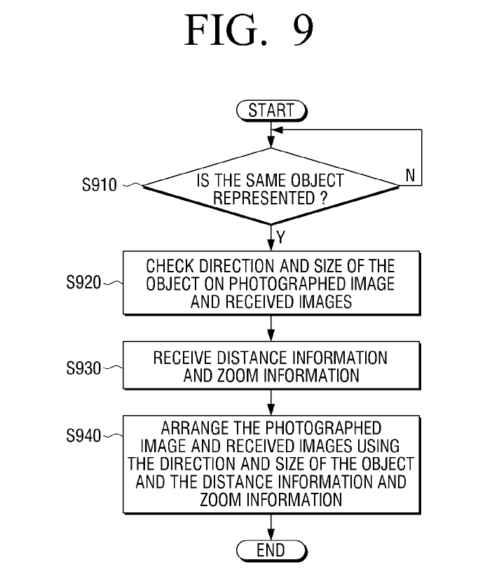

As described above, the controller 130 may control the photographed image and received images to be rearranged according to whether or not the photographed image and received images represent the same object. Hereinafter, this operation of the controller 130 is now described with reference to FIGS. 9 to 11.

FIG. 9 is a flowchart illustrating a process of rearranging a photographed image and one or more received images according to an exemplary embodiment of the present general inventive concept.

The controller 130 can determine whether or not the photographed image and one or more received images represent the same object in operation S910. To determine whether or not the same object appears on the photographed image and received images, a pixel by pixel comparison between these images may be performed with reduction scaling or magnification scaling. Additionally, if the object is a person, a method for detecting a face of the person may be used. To perform the pixel by pixel comparison or the face detection method, the photographing apparatus 100 may further include a pixel comparison unit 132 and/or a face detection unit 134.

If it is determined that the photographed image and received images represent the same object in operation S910-Y, the controller 130 may check the direction and size of the object on the photographed image and received images in operation S920. Additionally, the controller 130 may control the communication module 160 to receive from the external photographing apparatus 10 distance information and zoom information associated with the one or more images photographed by and received from the external photographing apparatus 10 in operation S930. Although the photographing apparatus 100 can receive the distance information and the zoom information after receiving the one or more images photographed by the external photographing apparatus 10, this is merely an example, and accordingly the present general inventive concept is also applicable to a situation in which the one or more images photographed by the external photographing apparatus 10 are received along with the distance information and the zoom information.

Subsequently, the controller 130 may arrange the photographed image and one or more received images using the direction and size of the object and the received distance information and zoom information in operation S940.

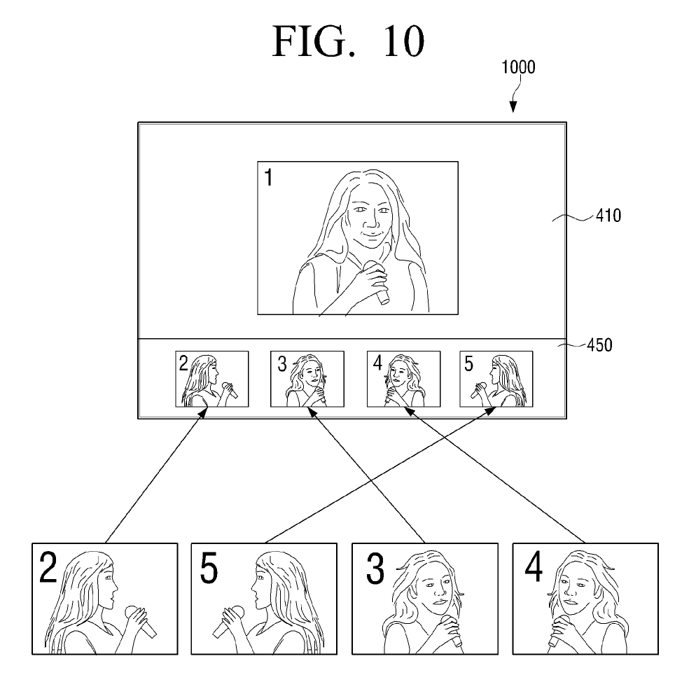

Hereinafter, a process of arranging a photographed image and one or more received images is described with reference to FIG. 10. FIG. 10 is a view illustrating a screen 1000 displayed when the photographed image and one or more received images are rearranged.

In FIG. 10, image 1 is photographed by the photographing apparatus 100, images 2 to 5 are received from the external photographing apparatus 10, and images 1 to 5 show the same object, namely, a specific person. In this situation, the controller 130 may detect a face of the person, and may rearrange images 1 to 5 so that image 1 may be displayed on the main area 410 and image 2 representing the right side of the face through image 5 representing the left side of the face may be displayed from the left to the right of the sub-area 450 in the order of the numbers assigned to the images.

Thus, it is possible for the user to easily compare images.

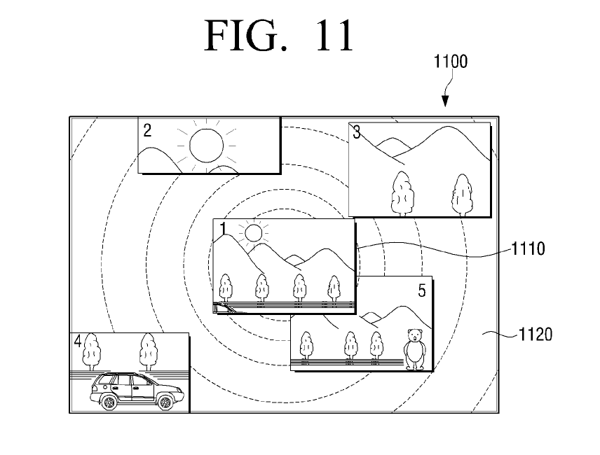

FIG. 11 is a view illustrating a screen 1100 displayed when a photographed image and received images are rearranged in a different manner from the screen of FIG. 10.

In FIG. 11, if not only a person but also things are photographed as objects, the controller 130 may compare a photographed image to one or more received images and rearrange the one or more received images around the photographed image. In this situation, the photographed image may be displayed on the main area 1110 on the center of the screen, and the one or more received images may be displayed on the sub-area 1120 excluding the main area 1110 of the screen.

The controller 130 may determine the display position of the received images based on objects appearing on the photographed image.

Referring to FIG. 11, an object identical to an object on an upper left side of image 1 is displayed on the lower center of image 2, and thus the controller 130 may control image 2 to be displayed on an upper left corner of the screen in the sub-area 1120. Additionally, an object identical to an object on a right side of image 1 is displayed on a lower left side of image 3, and thus the controller 130 may control image 3 to be displayed on an upper corner of the screen in the sub-area 1120. The photographing apparatus 100 or the external photographing apparatuses 10 may provide distance information, zoom information, directional information, size information, or other information about the photographed images. Alternatively, the controller 130 can determine the distance information, zoom information, directional information, size information. The controller 130 can use the provided (or determined) information to detect the position of at least one of the external photographing apparatuses 10, and can also be used to determine the display position of the images to be displayed in the sub-area 1120 relative to the image displayed in the main area 1110.

Likewise, the controller 130 may determine the display position of images 4 and 5, and may cause images 4 and 5 to be displayed on a determined position of the sub-area 1120 relative to image 1 displayed in the main area 1110.

Accordingly, it is possible for a user to more intuitively know where received images are displayed.

While FIG. 11 illustrates that the sub-area 1120 encloses the main area 1110, this is not intended as a limitation, and the sub-area 1120 may be positioned above, below, or to a side of the main area 1110 as well.

Therefore, it is possible for a user to view an image photographed by his or her own photographing apparatus together with a plurality of images photographed by a plurality of external photographing apparatuses, and thus to easily compare these images.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in distributed fashion. The computer-readable transmission medium can transmit carrier waves and signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A display method of a photographing apparatus, the method comprising:
displaying an image photographed by the photographing apparatus and at least one image received from at least one external photographing apparatus on a first area or a second area; and
changing a mode of at least one of the photographed image and the at least one received image if a display area of the at least one image is changed.

2. The display method of claim 1, wherein the first area is a moving image mode area on which a moving image is displayed, and the second area is a still image mode area on which a still image is displayed.

3. The display method of claim 2, wherein the changing of the mode comprises:
if a display area of the at least one received image is changed from the second area to the first area, transmitting a moving image request message to the at least one external photographing apparatus; and
displaying a moving image received from the at least one external photographing apparatus on the first area.

4. The display method of claim 2, wherein the changing of the mode comprises:
if a display area of the at least one received image is changed from the first area to the second area, transmitting a still image request message to the at least one external photographing apparatus; and
updating a still image received periodically from the at least one external photographing apparatus and displaying the updated image on the second area.

5. The display method of claim 1, further comprising:
if one image is selected from the first area, highlighting and recording the selected image.

6. The display method of claim 5, further comprising:
outputting the selected image along with an audio corresponding to the selected image.

7. The display method of claim 5, further comprising:
if the selected image is exchanged with a non-selected image, pausing recording of the selected image and starting recording of the non-selected image.

8. The display method of claim 1, wherein the second area encloses the first area.

9. The display method of claim 8, wherein the displaying of the photographed image and at least one received image comprises:
detecting a position of the at least one external photographing apparatus based on an object in the at least one received image; and
displaying the at least one received image around the photographed image according to the detected position.

10. The display method of claim 9, further comprising:
checking a direction and size of the object; and
receiving distance information and zoom information associated with the at least one external photographing apparatus from the at least one external photographing apparatus,
wherein the detecting of the position of the at least one external photographing apparatus comprises detecting the position of the at least one external photographing apparatus using at least one of the direction and size of the object and the distance information and zoom information.

11. The display method of claim 1, wherein the displaying of the photographed image and at least one received image comprises displaying the photographed image and at least one received image so that a size or position of either the photographed image or the at least one received image is changed according to the number of images displayed on the first area and the second area.

12. A display method comprising:
receiving a plurality of images from a plurality of external apparatuses;
dividing a screen into a plurality of areas; and
displaying each of the plurality of images in at least one of the plurality of areas in a display mode, based on the area of the screen on which the each of the plurality of images is displayed.

13. A photographing apparatus comprising:
a display unit to display an image photographed by the photographing apparatus and at least one image received from at least one external photographing apparatus on a first display area or a second display area; and
a controller to change a mode of at least one of the photographed image and the at least one received image if a display area of the at least one image is changed.

14. The photographing apparatus of claim 13, wherein the first display area is a moving image mode area on which a moving image is displayed and the second display area is a still image mode area on which a still image is displayed.

15. The photographing apparatus of claim 14, further comprising:
a communication module to communicate with the at least one external photographing apparatus,
wherein, if a display area of the at least one received image is changed from the second display area to the first display area, the controller controls the communication module to transmit a moving image request message to the at least one external photographing apparatus so that a moving image received from the at least one external photographing apparatus in response to the moving image request message is displayed on the first display area.

16. The photographing apparatus of claim 14, further comprising:
a communication module to communicate with the at least one external photographing apparatus,
wherein, if a display area of the at least one received image is changed from the first display area to the second display area, the controller controls the communication module to periodically transmit a still image request message to the at least one external photographing apparatus so that a still image received periodically from the at least one external photographing apparatus in response to the still image request message is updated and displayed on the second display area.

17. The photographing apparatus of claim 13, further comprising:
a storage unit to record an image,
wherein, if one image is selected from the first display area, the controller controls the selected image to be highlighted and recorded on the storage unit.

18. The photographing apparatus of claim 13, wherein the second display area encloses the first display area.

19. The photographing apparatus of claim 13, wherein the controller controls a size or position of either the photographed image or the at least one received image to be changed according to the number of images displayed on the first area and the second area.

20. The photographing apparatus of claim 13, wherein the display unit is a touch screen, and
the display area of at least one of the photographed image and the at least one received image is changed by a user input on the touch screen.
